(19) United States
(12) Patent Application Publication
(10) Pub. No.: US 2014/0013851 A1
(43) Pub. Date: Jan. 16, 2014

(54) SELF-POWERED SENSOR SYSTEM

(71) Applicant: Stichting IMEC Nederland, Eindhoven (NL)

(72) Inventors: Christinus Antonetta Paulus van Liempd, Schijndel (NL); Valer Pop, Leuven (NL); Jozef Franciscus Maria Oudenhoven, Eindhoven (NL)

(21) Appl. No.: 13/937,932

(22) Filed: Jul. 9, 2013

(30) Foreign Application Priority Data
Jul. 10, 2012 (EP) 12175723.1

(51) Int. Cl. G01H 11/06

(52) U.S. Cl. CPC G01H 11/06
USPC 73/658

(57) ABSTRACT

A self-powered sensor system includes an autonomous sensor unit including at least one energy harvester which converts an induced vibration into at least one electrical signal; a power management unit comprising analogue signal processing circuitry, said analogue signal processing circuitry being configured for extracting and generating, from said received at least one electrical signal, at least one digital output signal indicative of a sensed physical state and at least one electrical power signal; and at least one user unit comprising electronic circuitry being powered by said at least one electrical power signal and/or receiving said at least one digital output signal provided by said power management unit. The description also relates to an electronic or network system, a machine or part thereof, a tire or wheel, or a means of transport including a self-powered sensor system according to embodiments described herein.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims priority under 35 U.S.C. §119(a)-(d) to European Patent Application No. EP 12175723.1, filed Jul. 10, 2012, the disclosure of which is hereby incorporated by reference in its entirety.

### BACKGROUND

1. Field

The present description relates in general to the field of sensor systems and more specifically to self-powered sensor systems.

2. Description of the Related Technology

Self-powered sensor systems have become steadily standard components for use in monitoring applications and have become smaller, cheaper, and more sophisticated. Wide-scale deployment of these kinds of systems and applications depends primarily on their ability to operate for long periods of time and it is considered that, for the intended application lifetimes, this object is not reached when using batteries, due to size limitations and the need to recharge. Furthermore, environmental issues are of great importance for battery powered systems. Therefore, in order to improve system autonomy and lifetime, effort is ongoing to replace batteries with small and long lasting power sources like energy harvesters.

Energy harvesting or energy scavenging is the process of converting unused ambient energy into electrical power. Energy harvesting devices come in various forms, and can provide electrical power by means of vibration, thermal, photovoltaic and radiofrequency conversions.

A general block diagram of an exemplary self-powered sensor system 100 is presented in FIG. 1A. It comprises a sensor unit 110, a power and control unit 120, and a display and/or communication unit 130. The sensor unit 110 comprises, for example, at least one sensor device which converts a physical quantity or physical state into a signal, which is provided to the power and control unit 120 for evaluation and further process. The power and control unit 120 generally comprises, as shown in FIG. 1B, an Analog-to-Digital Converter (ADC) 121, a microprocessor or microcontroller 122, a power management module 123, and a power supply module 124. The power supply module 124 may comprise a battery and/or an energy harvesting device and is intended to provide enough electrical power for the operation of the entire sensor system 100. The power management module 123 is in charge of regulating and distributing the electrical power generated by the power supply module 124 to all the system modules and units, so that system operation is performed as expected. The ADC 121 converts the sensor unit output signal to a digital format to be processed by the microprocessor or microcontroller 122, which is in charge of performing algorithmic operations intended for system operation control and providing the necessary digital outputs to the display and/or communication unit 130. The display and/or communication unit 130 comprises means for displaying the data received from microprocessor or microcontroller 122 and/or transceiver means for transmitting and/or receiving information related to the self-powered sensor system 100.

Current state of the art self-powered sensor systems as described above are still associated with significant drawbacks, including high power consumption, manufacturing costs and large implementation area needed.

### SUMMARY

According to one exemplary embodiment of the description, there is provided a self-powered sensor system comprising: an autonomous sensor unit including at least one energy harvester which converts an induced vibration into at least one electrical signal; a power management unit comprising analogue signal processing circuitry configured to extract and generate, from the one electrical signal, at least one digital output signal indicative of a physical state being sensed and at least one electrical power signal; and at least one user unit comprising electronic circuitry being powered by said at least one electrical power signal and receiving said at least one digital output signal provided by said power management unit.

According to an exemplary embodiment of the description, by providing an autonomous sensor unit (including, in one example, an energy harvester) which does not need electrical power to generate at least one electrical signal and by providing analogue signal processing circuitry which can extract and generate, from a single electrical signal received from an energy harvester, at least one digital output signal indicative of a certain sensed physical state and at least one electrical power signal that can be used to power at least part of the additional electronic circuitry needed for the operation of the self-powered sensor system, the energy consumption, the manufacturing costs and/or the implementation area of the self-powered sensor system can be advantageously reduced. The self-powered sensor system, according to an exemplary embodiment of the description, comprises at least one autonomous sensor unit, which avoids the need to implement, as different entities or units, a sensor for sensing a certain physical state and an energy supply for providing power to the system circuitry. The self-powered sensor system, according to an exemplary embodiment of the description, combines in one single non-powered entity, for example the autonomous sensor unit, the sensing and the power supply functionality. The autonomous sensor unit, according to one exemplary embodiment of the description, includes at least one vibration energy harvester, which may comprise electrostatic, piezoelectric and/or electromagnetic transduction capabilities. Vibration energy, harvesters are of specific interest for environments where sinusoidal or repetitive shocks are present and can convert an induced vibration into an electrical signal. Also according to an exemplary embodiment of the description, a power management unit comprising analogue signal processing circuitry is advantageously combined with a vibration energy harvester in order to extract and generate at least one digital output signal indicative of a sensed physical state and at least one electrical power signal which can be used by other units of the system, in the following referred to as user units. The user units could be, but are not limited to, one or more of a display unit, a communications unit, a digital control unit, a battery, or at least another sensor unit. Additionally and advantageously, the self-powered sensor unit according to an exemplary embodiment of the description has its own embedded analogue intelligence and therefore does not require, for extracting certain physical sensed states, the use of ADCs, microprocessors, or microcontrollers, memories or algorithms, which would increase energy consumption, implementation area and system complexity. Therefore, by decreasing the number of complex components or units needed for performing the sensing, processing, and/or power supply functionality, the self-powered sensor unit according to an exemplary embodiment of the description reduces size, maintenance problems, and costs, and increases robustness and reliability of the system. As a result, the life-time and autonomy of such self-powered sensor systems according to the present description is increased. Furthermore, processing time may be improved.

According to another exemplary embodiment of the description, the analogue signal processing circuitry unit is further configured to provide at least one power control signal to indicate to one or more user units when the power is available for operation. Therefore, the power management unit can advantageously indicate to the one or more user units the time point when the optimum electrical power signal its present for use and/or control the use of power by the one or more user units.

According to still another exemplary embodiment of the description, the analogue signal processing circuitry is configured to generate a first and a second electrical power signal with different regulated voltage outputs and a corresponding first and second power control signal to indicate to one or more user units when each of the electrical power signals is available for operation. Therefore, the power management unit can further advantageously operate and generate, from a single rectified input DC voltage, two supply voltages to one or more user units.

According to still another exemplary embodiment of the description, the analogue signal processing circuitry is configured to generate the second electrical power signal with a regulated voltage higher than the regulated voltage of the first electrical power signal, and configured to provide the first electrical power signal to the one or more user units for a longer period of time than the second electrical power signal. Therefore, the power management unit can further advantageously operate and generate, from a single rectified input DC voltage, two supply voltages, with different characteristics and values, to one or more user units.

According to still another exemplary embodiment of the description, the analogue signal processing circuitry is configured to extract and generate, from said received at least one electrical signal, a first digital output signal representing a detected number of mechanical shocks. Therefore, the power management unit can advantageously extract and generate, using a low power analogue signal processing circuitry, a digital representation of a feature being sensed by the harvester, in this example a number of mechanical shocks. According to still another exemplary embodiment of the description, the first digital output signal representing a detected number of mechanical shocks is calculated based on a scaled forward current copy generated by the analogue signal processing circuitry. Therefore, further power can be reduced. In other embodiments, a first digital output signal represents vibration, rotation, speed, force, or power.

According to still another exemplary embodiment of the description, the analogue signal processing circuitry is configured to extract and generate, from said received at least one electrical signal, a second digital output signal representing a detected harvested energy. Therefore, the power management unit can advantageously extract and generate, using a low power analogue signal processing circuitry, a digital representation of a feature being sensed by the harvester, namely a representation of the harvested energy.

According to still another exemplary embodiment of the description, the analogue signal processing circuitry comprises a single bridge rectifier which receives the at least one electrical signal, so that the analogue signal processing circuitry advantageously further reduces the use of rectifier components in order to operate and reduce energy consumption.

The description also relates to an electronic system or network, a machine or part thereof, a tire or a wheel, or a means of transport comprising a self-powered sensor system according to any embodiment herein claimed.

In another exemplary embodiment of the description, a self-powered sensor system includes means for converting an induced vibration into at least one electrical signal. The system also includes means for extracting and generating, from said at least one electrical signal, an output, the output including at least one digital output signal indicative of a sensed physical state and at least one electrical power signal. The system further includes means for receiving the output, the receiving means powered by the at least one electrical power signal and configured to transmit the at least one digital output signal, and/or state representations derived from the received digital output signal.

In yet another exemplary embodiment of the description, a method of monitoring a physical condition using a self-powered monitoring system includes converting an induced vibration into at least one electrical signal. The method also includes extracting and generating, from the at least one electrical signal, at least one digital output signal indicative of a sensed physical condition and at least one electrical power signal. The method further includes powering a unit of the system using the at least one electrical power signal; and transmitting the at least one digital output signal, and/or state representations derived from the received digital output signal.

Certain objects and advantages of various inventive aspects have been described above. It is to be understood that not necessarily all such objects or advantages may be achieved in accordance with any particular embodiment. Those skilled in the art will recognize that the invention may be embodied or carried out in a manner that achieves or optimizes one advantage or group of advantages without necessarily achieving other objects or advantages as may be taught or suggested herein.

### BRIEF DESCRIPTION OF THE DRAWINGS

The accompanying drawings illustrate one or more exemplary embodiments and further serve to explain the principles of the present description.

FIGS. 1A and 1B are block diagrams illustrating an exemplary self-powered sensor system.

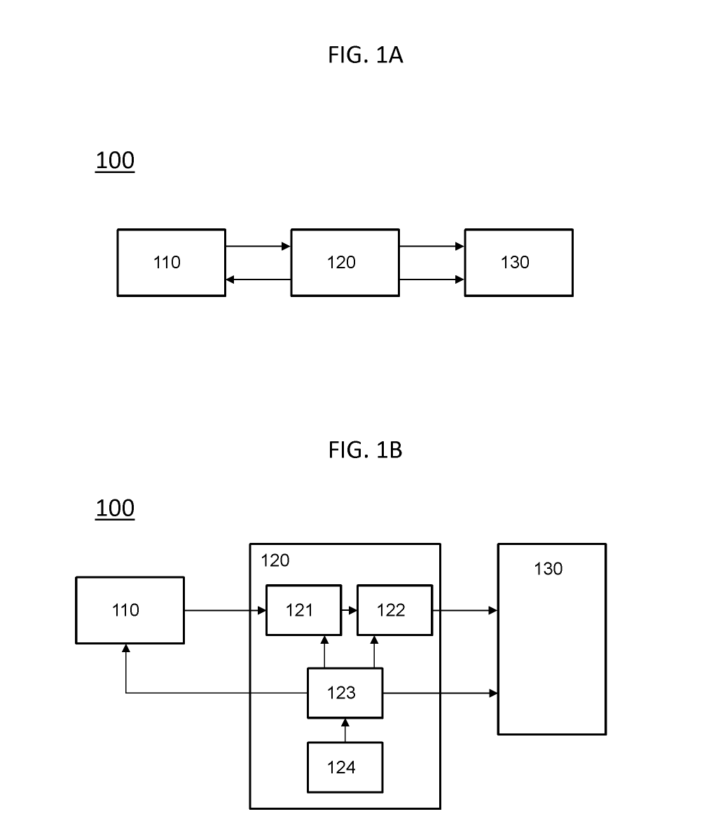

FIGS. 2A and 2B are block diagrams illustrating a self-powered monitoring system according to an embodiment of the present description.

FIG. 3 is a block diagram illustrating an exemplary embodiment of a first analog processing circuit, in the power management unit of FIG. 2B, designed for shock detection.

FIG. 4 is a block diagram illustrating an exemplary embodiment of a second analog circuit, in the power management unit of FIG. 2B, designed for voltage regulation and harvested energy detection.

FIG. 5 illustrates time graphs of the output electrical power signals and power control signals provided by a power management unit according to an embodiment of the present description.

FIG. 6 illustrates the power output of a vibration energy harvester in a particular application environment according to an embodiment of the present description.

### DETAILED DESCRIPTION

In the following, it should be appreciated that in the description of exemplary embodiments, various features are sometimes grouped together in a single embodiment, figure, or description thereof for the purpose of streamlining the disclosure and aiding in the understanding of one or more of the various inventive aspects. This is however not to be interpreted as the invention requiring more features than those claimed.

Furthermore, while some embodiments described herein include some but not other features included in other embodiments, combinations of features of different embodiments are meant to be within the scope of the invention, and form different embodiments, as would be understood by those skilled in the art.

In the following detailed description, numerous specific details are set forth in order to provide a thorough understanding of the disclosure and how it may be practiced in particular embodiments. However, it will be understood that the present disclosure may be practiced without these specific details. In other instances, well-known methods, procedures and techniques have not been described in detail, so as not to obscure the present disclosure. While the present disclosure will be described with respect to particular embodiments and with reference to certain drawings, the disclosure is not limited hereto. The drawings included and described herein are schematic and are not limiting the scope of the disclosure. It is also noted that in the drawings, the size of some elements may be exaggerated and, therefore, not drawn to scale for illustrative purposes.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

The term “comprising” should not be interpreted as being restricted to the means listed thereafter; it does not exclude other elements or steps. It is thus to be interpreted as specifying the presence of the stated features, integers, steps, or components as referred to, but does not preclude the presence or addition of one or more other features, integers, steps, or components, or groups thereof. Thus, the scope of the expression “a device comprising means A and B” should not be limited to devices consisting only of components A and B.

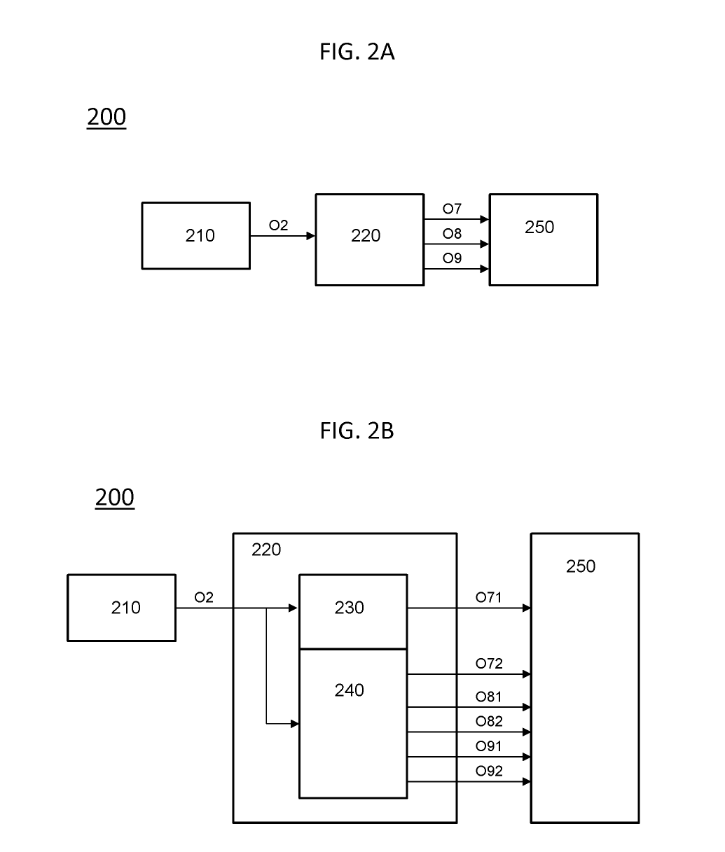

FIG. 2A is a block diagram illustrating a self-powered monitoring system 200 according to an exemplary embodiment the description, comprising an autonomous sensor unit 210, a power management unit 220, and one or more user units 250, which is/are represented in the figure as a single general block. The autonomous sensor unit 210 generates and provides an electrical signal O2 to the power management unit 220, which, from that received electrical signal, extracts and generates at least one digital output signal O7 indicative of a certain sensed or detected physical state and at least one electrical power signal O8 intended, for example, for powering the user unit 250. Advantageously, the power management unit 220 may further generate at least one power control signal O9 to indicate to the user unit 250 when the power is available for operation and/or ready for use. The user unit 250, which may be, for example, one or more of a display unit, a communications unit, a digital control unit, a battery or at least another sensor unit, receives and uses at least one of the outputs generated by the power management unit 220, either for powering its electronic circuitry during a certain period of time or using the one or more digital output signals for further processing or operation. Advantageously, a user unit 250 may use at least one digital output signal O7 indicative of a sensed physical state and at least one electrical power signal O8 for its operation. Furthermore, a user unit 250 may use at least one power control signal O9 for its operation.

The self-powered sensor system 200 according to an exemplary embodiment of the description advantageously combines in one single non-powered entity, the autonomous sensor unit 210, the sensing and the power supply functionality. The autonomous sensor unit 210 according to one exemplary embodiment can include at least one vibration energy harvester, which may comprise electrostatic, piezoelectric, and/or electromagnetic transduction capabilities. An example of a vibration energy harvester is described, for example, in the paper “Shock induced energy harvesting with MEMS harvester for automotive applications,” R. Elfrink, S. Matova, C. de Nooijer, M. Jambunathan, M. Goedbloed, J. van de Molengraft, V. Pop, R. J. M. Vullers, M. Renaud and R. van Schaijk, IEEE 2011, IEDM11-677 to 680.

According to an exemplary embodiment, the power management unit 220 comprises analogue signal processing circuitry and can be advantageously combined with a vibration energy harvester in order to extract and generate, from the electrical signal provided by the energy harvester, at least one digital output representing a certain sensed physical state such as, for example, but not limited to, vibration, rotation, speed, shocks, force, and/or power and at least one electrical power signal which can be used by one or more user units 250. In one embodiment, the power management unit 220 advantageously converts an irregular energy flow from the energy harvester into a regulated power signal and at least this condition may be signaled to the user unit 250 by means of a power control signal O9. Alternatively, the received irregular energy flow may be, in some cases, used directly by the user unit 250′ for operation purposes. The analogue signal processing circuitry of the power management unit 220 advantageously extracts and detects one or more specific states of interest from a single electrical signal generated by at least one energy harvester. According to one embodiment, a user unit 250 may be a communications unit, which receives at least one digital output signal O7 representing a certain physical state, for example, but not limited to, vibration, rotation, speed, shocks, force, and/or power and then transmits such, signal, and/or other state representations derived from that received digital output signal representation, via wired or wireless communication systems or means.

FIG. 2B is a block diagram illustrating another exemplary embodiment of a self-powered monitoring system 200, comprising an autonomous sensor unit 210, a power management unit 220, and one or more user units 250, which are represented in the figure as a general single block. Similar to the autonomous sensor unit 210 described in FIG. 2A, such unit generates and provides, also according to the description above, at least one electrical signal O2 to the power management unit 220. The power management unit 220 comprises a first analogue signal processing circuit 230 configured for extracting and generating, from the received electrical signal O2, a first digital output signal O71 representing a detected number of shocks. The power management unit 220 further comprises a second analogue signal processing circuit 240 configured for extracting and generating, from the received electrical signal O2, a second digital output signal O72 representing a detected harvested energy. The power management unit 220 further comprises analogue signal processing circuitry for generating a first and a second electrical power signal O81, O82 with different regulated voltage outputs and generating a corresponding first and second power control signal O91, O92 for indicating to one or more user units 250 when each of the electrical power signals is available for operation. It shall be understood that, although, for the sake of simplification and clarity, the analogue signal processing circuitry of the power management unit 220 has been split in two different circuits 230, 240, those circuits may be implemented as a single analogue circuit providing all the above referenced outputs.

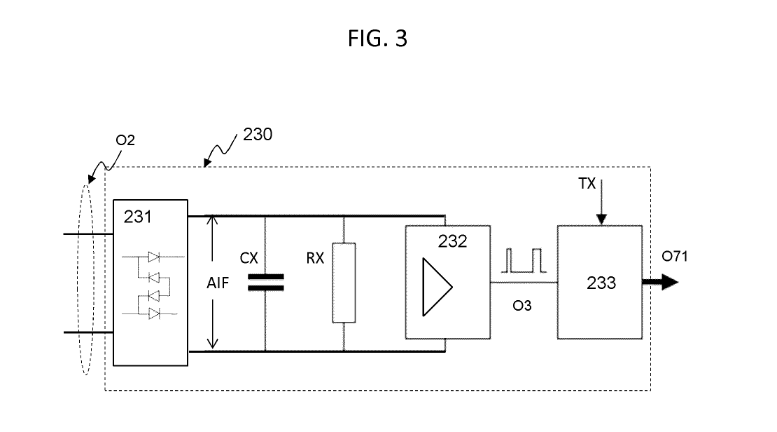

FIG. 3 is a block diagram illustrating an exemplary embodiment of the first analogue signal processing circuit 230 in the power management unit 220 illustrated in FIG. 2B. The first analogue signal processing circuit 230 according to an exemplary embodiment is designed for detecting mechanical shocks, a shock being a sudden acceleration or deceleration. The first analogue signal processing circuit 230 according to an exemplary embodiment comprises an active bridge rectifier circuit 231, a capacitor CX, a resistor RX, a shock sensing circuit 232, and a counter circuit 233 which is enabled during a certain period of time TX.

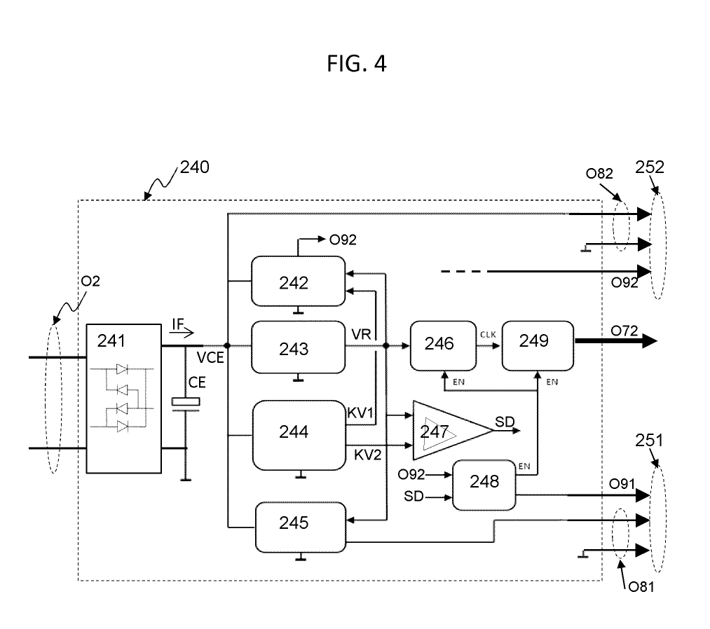

The active bridge rectifier circuit 231 includes current controlled active diodes which provide a scaled forward current copy AIF of a charge current IF (shown in FIG. 4). The scaled current copy AIF is a copy proportional to the charge current IF, said proportion being defined by a constant substantially smaller than one in order to enable low power consumption by the first analogue signal processing circuit 230. The scaled forward current copy AIF charges an RC network CX, RX, which define a time constant TX. The shock sensing circuit 232 includes a peak detector and a comparator, and a pulsed output O3 to the counter circuit 233. In one embodiment, the time constant TX, wherein TX=RX×CX, should be chosen such that the best detectable shape is obtained. The counter circuit 233 provides a first digital output signal O71, by means, for example, of a plurality of bits, representing a detected number of shocks. It shall be understood that from the detected shock information, for example, shock frequency and number of shocks, further useful characteristics may be also extracted, for example, speed or distance information, by means of further processing calculations. The first analogue signal processing circuit 230 allows extracting shock information from an energy harvester while an energy storage capacitor CE (shown in FIG. 4) is charging.

FIG. 4 is a block diagram illustrating an exemplary embodiment of the second analogue signal processing circuit 240 in the power management unit 220 illustrated in FIG. 2B. The second analogue signal processing circuit 240 according to an exemplary embodiment is designed for providing voltage regulation and harvested energy detection. The second analogue signal processing circuit 240 according to an exemplary embodiment comprises an active bridge rectifier circuit 241, an energy storage capacitor CE being charged by a charge current IF, a shunt regulator circuit 242, a voltage reference circuit 243, a voltage attenuator circuit 244, a low dropout regulator circuit 245, a relaxation oscillator circuit 246, a comparator 247, a logic circuit 248, and a power counter circuit 249.

The active bridge rectifier circuit 241 converts alternating current energy, from a vibration energy harvester, into direct current (DC) energy, represented in the figure as an input DC voltage VCE. The voltage reference circuit 243 provides a constant DC electrical output signal as reference voltage VR having a constant reference voltage to ground. The voltage attenuator circuit 244 provides two linear attenuated output voltages KV1, KV2, derived from the input DC voltage VCE, with attenuation factors K1 and K2. The shunt regulator circuit 242 functions as an ideal clamp, so that if the input DC voltage VCE is lower than a certain threshold voltage the input current is zero. In one embodiment, the input voltage is never allowed to be larger than threshold voltage, and, in that case, the shunt regulator circuit 242 clamps the input voltage to the threshold and shunts all input current to ground. The shunt regulator circuit 242 activates a second power control signal O92 when it is in clamp mode. The low dropout regulator circuit 245 is a linear series voltage regulator that provides a first electrical power signal O81, which is a regulated DC output voltage signal, when the input DC voltage VCE is larger than said regulated DC output voltage signal. The relaxation oscillator circuit 246 provides a clock signal output CLK, with a constant frequency, when its enable input EN is active. The power counter circuit 249 counts the periods of the clock signal output CLK during a certain time when its enable input EN is active. The power counter circuit 249 provides a second digital output signal O72, by means, for example, of a plurality of bits, representing a detected harvested energy. The comparator 247 provides a startup detection indication signal SD when the input DC voltage VCE has reached a certain minimal threshold voltage. The logic circuit 248 generates an enable output signal EN in a time slot after the startup detection indication signal SD becomes active and until the second power control signal O92 becomes active and generates a first power control signal O91 in the time slot after the second power control signal O92 becomes active and until the startup detection indication signal SD is deactivated. The second analogue signal processing circuit 240 also provides a second electrical power signal O82, which is the input DC voltage VCE shunted by the shunt regulator circuit 242.

Advantageously, the second analogue signal processing circuit 240, according to an exemplary embodiment, operates on a single rectified input DC voltage VCE to provide two energy aware intermittent supply voltages to users, referred to as a first and a second electrical power signal O81, O82. In addition, the second analogue signal processing circuit 240 senses the harvested energy during intermittent periods, represented by a digital output signal, referred as the second digital output signal O72.

A shunt regulator circuit 242 and a low dropout regulator circuit 245 are used to provide regulated supply voltages. A low power reference voltage VR provides an accurate reference for generating a startup detection indication signal SD, the shunt regulator circuit output voltage and the low dropout regulator circuit regulated output voltage. The startup detection indication signal SD and a second power control signal O92 are used to provide the enabling time slot for the relaxation oscillator circuit 246 and the power counter circuit 249. The shunted output voltage, referred to as the second electrical power signal O82 may be supplied to an auxiliary user unit. The first and the second power control signals O91, O92 indicate that respectively the first and the second electrical power signals O81, O82 are in regulation and can be used.

According to one exemplary embodiment, the power management unit 220 provides the first electrical power signal O81 and the first power control signal O91 to a first or main user unit 251 and the second electrical power signal O82 and the second power control signal O92 to a second or auxiliary user unit 252.

According to one exemplary embodiment, the power management unit 220 comprises a single active bridge rectifier circuit, which is used by both the first and the second analogue signal processing circuit 230, 240, and the analogue signal processing circuitry is configured for, from that single active bridge rectifier circuit, generating both the charge current IF and the scaled forward current copy AIF of that charge current IF.

It shall be understood that although some elements of the analogue signal processing circuitry according to an exemplary embodiment deal with digital-like signals and logic digital-like circuits, they do not deal with bits of information and follow digital bit instructions, as could be the case with a microcontroller, for generating a digital-like or digital compatible signal.

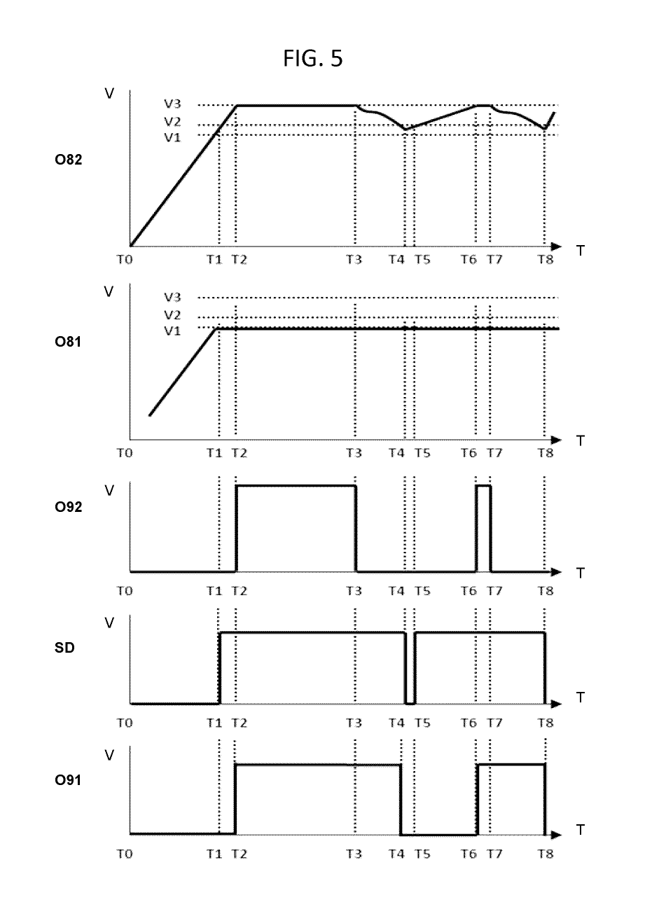

FIG. 5 illustrates an exemplary representation of the time graphs of the output electrical power signals O81, O82 and power control signals O91, O92 provided by the second analogue signal processing circuit 240 of FIG. 4. According to an exemplary embodiment, the second analogue signal processing circuit 240 also generates, for example, a startup detection indication signal SD for internal operation control of the power management unit 220.

The timing diagram of FIG. 5 shows the relations when the rectified input DC voltage VCE (shown in FIG. 4) changes, that is, when, after a period of rest, the energy harvester is exposed again, at a certain initial time T0, to mechanical vibration of its sensing and harvesting mechanism. This may happen, for example, when the self-powered sensor system according to an exemplary embodiment is used to extract information from a certain machine, apparatus or part thereof, which has been at a rest or standby state during a certain period of time and said machine, apparatus or part thereof starts inducing a vibration in the energy harvester. This may also happen, for example, when the self-powered sensor system according to an exemplary embodiment is used to extract information from a tire or a wheel, once the tire or wheel has been at rest during a certain period of time and at a certain point such tire or wheel changes state and starts inducing a vibration in the energy harvester. At that point, the self-powered sensor system according to an exemplary embodiment starts harvesting energy and the rectified input DC voltage VCE rises up to a first voltage threshold V1 and the low dropout regulator circuit 245 starts regulating. Shortly after the rectified input DC voltage VCE passes a second voltage threshold V2, for example when a second linear attenuated output voltage KV2 equals the reference voltage VR, at a first time point T1, the analogue circuit activates the startup detection indication signal SD and an enable signal EN so that the power counter circuit 249 counts pulses of the clock signal output CLK. The power counter circuit 249 counts pulses until the voltage reaches a third voltage threshold V3, for example when a first linear attenuated output voltage KV1 equals the reference voltage VR, at a second time point T2. According to an exemplary embodiment, the power counter circuit 249 provides, at the second time point T2, a digital output signal or value, referred in FIG. 4 as the second digital output signal O72, representing the time passed between the second and the third voltage thresholds V2, V3, thus providing an indication of the harvested power. Also according to an exemplary embodiment, the power counter circuit 249 provides a digital output value signal which is proportional to the inverse of the harvested energy. Also at the second time point T2, the shunt regulator circuit 242 starts limiting the voltage and the first and second power control signal O91, O92 are activated to indicate to the main and/or the auxiliary user unit 251, 252 that they are allowed to use the corresponding output electrical power signals O81, O82 for powering their electronic circuitry and thereby start or resume operation. At a certain time point, for example a third time point T3, and due to the use of the power provided by the power management unit, the rectified input DC voltage VCE may be caused to decrease, for example when the used power is higher than the average harvested power. According to an exemplary embodiment, when the shunt regulator circuit loses regulation at the third time point T3, an indication is provided, for example by deactivating the second power control signal O92, to the auxiliary user unit 252 that it shall stop using the second electrical power signal O82. Also according to an exemplary embodiment, when the rectified input DC voltage VCE further decreases in voltage, to for example, approximately the second voltage threshold V2 minus a little hysteresis, at a fourth time point T4, an indication is provided, for example by deactivating the first power control signal O91, to the main user unit 251 that it shall stop using the first electrical power signal O81. As a result the rectified input DC voltage VCE raises again until the second voltage threshold V2 is again reached at a fifth time point T5. According to an exemplary embodiment, at the fifth time point T5 the power counter circuit 249 is reset and starts counting pulses again until the voltage reaches the third voltage threshold V3 at a sixth time point T6. The power counter circuit 249 provides, at the sixth time point T6, a digital output signal or value representing the time passed between the second and the third voltage thresholds V2, V3, thus providing an indication of the harvested power. The indication of the harvested power is updated every intermittent power cycle, which depends on the harvested power, the value of the energy storage capacitor CE and the used power. The time graph following the sixth time point T6 can be understood from what has been explained above for the time between the second time point T2 and the fourth time point T4. It shall be understood that the above described embodiments do not imply the essentiality to connect two different user units to the power management unit, and that a person skilled in the art can derive other embodiments from the ones herein explained, for example, connecting just one user unit to the power management unit or connecting just one user unit to the two electrical power signals or modifying the internal control signals so that the digital representation of the detected harvested power is provided with a different indication, for example, an accumulated value, a peak value, and integral, etc.

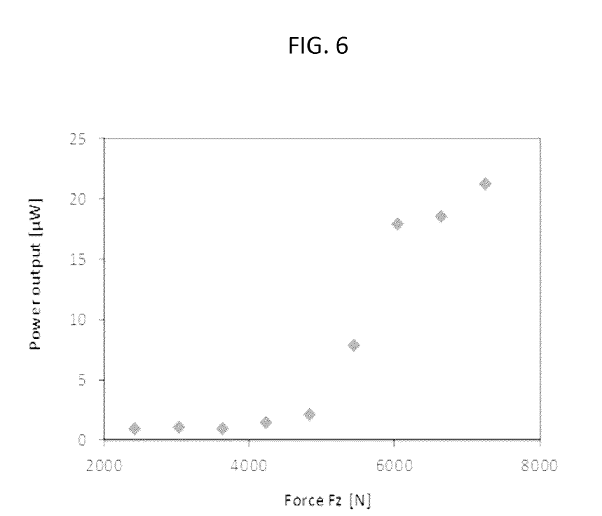

FIG. 6 illustrates the power output of a vibration energy harvester in a particular application environment according to an exemplary embodiment. The self-powered sensor system according to an exemplary embodiment may be used in an application environment intended to extract and monitor, from the detected information about the harvested energy, the load applied on a vehicle tire or wheel. The figure shows that the power output of an energy harvester is a function of the load applied on the tire or wheel. In this specific case, the energy harvester was mounted inside a car tire and the power output of the harvester was monitored while driving at a constant speed of 60 km/h. This experiment was repeated while increasing the load Force Fz on the wheel from 2410 to 7240 Newton. This load is applied on the wheel in the direction of the road surface, mimicking an increase in vehicle mass. The results of these experiments showed that the load has a positive correlation with the power output, and it is therefore demonstrated that the power output can be used as an indication of the load of the vehicle, when the other conditions, e.g. vehicle speed, remain unchanged.

The self-powered sensor system according to any of the embodiments herein described may be used in, but are not limited to, for example, transport means or machine monitoring and/or control applications. Examples of such applications are machine or engine monitoring and control systems, failure mechanism monitoring and control or intelligent tire monitoring and control systems, and control or machine failure. Other industrial applications could include those where, for example, monitoring and/or control of the vibrations of machinery or equipment is required for research, tolerance or maintenance. Advantageously, such monitoring and control system applications can benefit from the self-powered sensor system according to an exemplary embodiment of the description that consumes only nanowatts of power. An example of an application that can greatly benefit from the use of a self-powered sensor system according to an exemplary embodiment of the description are so called intelligent tire systems used in the automotive industry to monitor, for example, road, tire and/or wheel conditions. In a particular application example, the intelligent tire electronics comprising a self-powered sensor system according to an exemplary embodiment of the description can be located inside a transport means wheel. In another particular application environment the self-powered sensor system according to an exemplary embodiment of the description may be mounted on the wheel rim or in the wheel arches. In some application environments, the self-powered sensor system according to an exemplary embodiment of the description can be mounted inside a tire so that specific tire parameters can be captured. It is understood that other locations for mounting the self-powered sensor system according to an exemplary embodiment of the description are not excluded and may be similarly used for applications that benefit from the embodiments herein described. In general, other characteristics of the harvester output signal can be used for extracting vehicle and tire specific information, e.g. peak value, amplitude, integral, width of the signal. Moreover, mathematical formulae and algorithms may be used, based on physical models, empirical relations, and/or state estimation techniques.

The components of a self-powered sensor system according to an exemplary embodiment of the description can be integrated on a substrate, for example, in a single substrate, and either in flexible, e.g. foil, or rigid, e.g. silicon, form. The components may also be implemented as discrete electronic components mounted on a Printed Circuit Board.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

It will be appreciated that, for clarity purposes, the above description has described embodiments with reference to different functional units. However, it will be apparent that any suitable distribution of functionality between different functional units may be used without detracting from the invention. For example, functionality illustrated to be performed by separate computing devices may be performed by the same computing device. Likewise, functionality illustrated to be performed by a single computing device may be distributed amongst several computing devices. Hence, references to specific functional units are only to be seen as references to suitable means for providing the described functionality, rather than indicative of a strict logical or physical structure or organization.

Embodiments of the present disclosure are described above and below with reference to flowchart and block diagram illustrations of methods, apparatus, and computer program products. It will be understood that each block of the flowchart illustrations, and combinations of blocks in the flowchart illustrations, can be implemented by execution of computer program instructions. These computer program instructions may be loaded onto a computer or other programmable data processing apparatus (such as a controller, microcontroller, microprocessor or the like) in a sensor electronics system to produce a machine, such that the instructions which execute on the computer or other programmable data processing apparatus create instructions for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks presented herein.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A self-powered sensor system comprising:
an autonomous sensor unit including at least one energy harvester configured to convert an induced vibration into at least one electrical signal;
a power management unit comprising analogue signal processing circuitry, said analogue signal processing circuitry configured to extract and generate, from said received at least one electrical signal, at least one digital output signal indicative of a sensed physical state and at least one electrical power signal; and
at least one user unit comprising electronic circuitry being powered by said at least one electrical power signal and/or receiving said at least one digital output signal provided by said power management unit.

2. The self-powered sensor system according to claim 1, wherein the analogue signal processing circuitry is further configured to provide at least one power control signal to indicate to the at least one user unit when the power is available for operation.

3. The self-powered sensor system according to claim 2, wherein the analogue signal processing circuitry is configured to generate a first and a second electrical power signal with different regulated voltage outputs and a corresponding first and second power control signal to indicate to the at least one user unit when each of the electrical power signals is available for operation.

4. The self-powered sensor system according to claim 3, wherein the analogue signal processing circuitry is configured to generate the second electrical power signal with a regulated voltage higher than the regulated voltage of the first electrical power signal, and wherein the analogue signal processing circuitry is configured to provide the first electrical power signal to the at least one user unit for a longer period of time than the second electrical power signal.

5. The self-powered sensor system according to claim 1, wherein the analogue signal processing circuitry is configured to extract and generate, from said received at least one electrical signal, a first digital output signal representing a detected number of mechanical shocks.

6. The self-powered sensor system according to claim 5, wherein the analogue signal processing circuitry is configured to generate a scaled forward current copy of a charge current, said scaled forward current copy being proportional to said charge current by a constant substantially smaller than one, and wherein the analogue signal processing circuitry is further configured to generate the first digital output signal representing a detected number of mechanical shocks, based on the scaled forward current copy.

7. The self-powered sensor system according to claim 1, wherein the analogue signal processing circuitry is configured to extract and generate, from said received at least one electrical signal, a second digital output signal representing a detected harvested energy.

8. The self-powered sensor system according to claim 5, wherein the analogue signal processing circuitry comprises a single bridge rectifier which receives said at least one electrical signal.

9. An electronic or network system comprising a self-powered sensor system according to claim 1.

10. A machine or part thereof comprising a self-powered sensor system according to claim 1.

11. A tire or wheel comprising a self-powered sensor system according to claim 1.

12. A means of transport comprising a self-powered sensor system according to claim 1.

13. A self-powered sensor system comprising:
means for converting an induced vibration into at least one electrical signal;
means for extracting and generating, from said at least one electrical signal, an output, the output including at least one digital output signal indicative of a sensed physical state and at least one electrical power signal; and
means for receiving the output, the receiving means powered by the at least one electrical power signal and configured to transmit the at least one digital output signal, and/or state representations derived from the received digital output signal.

14. The self-powered sensor system according to claim 13, wherein the converting means includes at least one energy harvester.

15. The self-powered sensor system according to claim 13, wherein the means for extracting and generating includes analogue signal processing circuitry.

16. The self-powered sensor system according to claim 13, wherein the receiving means includes one or more of a display unit, a communications unit, a digital control unit, a battery, and a sensor unit.

17. The self-powered sensor system according to claim 13, wherein the at least one digital output signal represents a detected number of shocks, vibration, rotation, speed, force, or power.

18. The self-powered sensor system according to claim 13, wherein the at least one digital output signal represents a detected harvested energy.

19. A method of monitoring a physical condition using a self-powered monitoring system, the method comprising:
converting an induced vibration into at least one electrical signal;
extracting and generating, from the at least one electrical signal, at least one digital output signal indicative of a sensed physical condition and at least one electrical power signal;
powering a unit of the system using the at least one electrical power signal; and
transmitting the at least one digital output signal, and/or state representations derived from the received digital output signal.

20. The method according to claim 19, wherein the unit includes one or more of a display unit, a communications unit, a digital control unit, a battery, and a sensor unit, and wherein the sensed physical condition includes a vibration, a rotation, a speed, a number of shocks, a force, or power.
